(19) United States
(12) Patent Application Publication
(10) Pub. No.: US 2013/0271500 A1
(43) Pub. Date: Oct. 17, 2013

(54) LED Backlight Driving Circuit, Backlight Module, and LCD Device

(71) Applicants: Dongsheng Guo, Shenzhen (CN); Xiang Yang, Shenzhen (CN)

(72) Inventors: Dongsheng Guo, Shenzhen (CN); Xiang Yang, Shenzhen (CN)

(21) Appl. No.: 13/504,959

(22) PCT Filed: Apr. 16, 2012
(86) PCT No.: PCT/CN12/74081

§ 371 Date: Apr. 29, 2012

(30) Foreign Application Priority Data
Apr. 11, 2012 (CN) 201210104115.6

(51) Int. Cl. G09G 3/36; G09G 5/10; H05B 37/00

(52) U.S. Cl. 345/690; 315/192; 315/193; 345/102

(57) ABSTRACT

The invention provides an LED backlight driving circuit, a backlight module, and an LCD device. The LED backlight driving circuit includes LED light string(s); an anode of the LED light string is connected with a boost circuit, and a cathode of the LED light string is connected with a buck-boost circuit. The invention has the advantages that the limitation of the maximum voltage supplied by the single boost circuit is broken, the voltage difference between both ends of the LED light string is added, namely more LED lights can be connected in series in a single channel. Therefore, the requirement is met by a single string of LEDs or few strings of LEDs instead of the original multiple strings of LEDs, the difficulty of the current sharing of the LED light strings is reduced, the type selection of current sharing IC is convenient, equipment involved therein doesn't need a high voltage resistance, and the use of the current sharing IC is reduced, thereby favoring cost reduction.

### TECHNICAL FIELD

The invention relates to the field of liquid crystal displays (LCDs), and more particularly to a light emitting diode (LED) backlight driving circuit, a backlight module, and an LCD device.

### BACKGROUND

An LCD device includes an LCD panel and a backlight module. The backlight module generally employs LED(s) as a light source. Because the brightness provided by an individual LED is limited, LEDs are connected in series to provide sufficient brightness. As shown in FIG. 1, a conventional boost circuit is used for driving the LEDs by boosting voltage, and the voltage is boosted from 24 V to +100 V generally. The boosting range of the boost circuit is limited. If the number of LEDs is more, a plurality of LED strings must be arranged for keeping a constant current, and each string of LEDs require a channel for keeping the constant current. The more the channels are, the more difficult the design of the corresponding constant current ICs is, and the more the required constant current ICs are.

### SUMMARY

In view of the above-described problems, the aim of the invention is to provide a low-cost LED backlight driving circuit, a backlight module, and an LCD device capable of reducing the difficulty of LED current sharing.

The aim of the invention is achieved by the following technical schemes.

An LED backlight driving circuit comprises LED light string(s); an anode of the LED light string is connected with a boost circuit, and a cathode of the LED light string is connected with a buck-boost circuit.

Preferably, the input voltage of the boost circuit is consistent with that of the buck-boost circuit. Thus, the input ends of the boost circuit and the buck-boost circuit are in short connection with the same power source, favoring circuit simplification.

Preferably, the input voltage of the boost circuit is higher than that of the buck-boost circuit. Because both the boost circuit and the buck-boost circuit have a certain adjustment range based on the input voltage, the input voltage of the boost circuit is high, and the boosted voltage thereof is higher; the input voltage of the buck-boost circuit is low, and the bucked voltage thereof is lower. Therefore, the voltage difference between both ends of the LED light string can be further added, which means that the single LED light string can drive more LEDs. Thus, the number of LED light strings is further reduced, the difficulty of current sharing is reduced, the use of the current sharing ICs is reduced, and the cost is further reduced.

Preferably, the buck-boost circuit comprises a second controllable switch for energy storage, and a second diode; one end of the second controllable switch is connected with a power source, the other end of the controllable switch is connected with an anode of the second diode. A cathode of the second diode is connected with the cathode of the LED light string; a second energy storage capacitor is connected in series between the cathode of the second diode and a ground terminal of the power source; and a second energy storage inductor is connected in series between the anode of the second diode and the ground terminal of the power source. This is a specific structure of the buck-boost circuit.

Preferably, the boost circuit comprises a first energy storage inductor, and a first diode; one end of the first energy storage inductor is connected with a power source, the other end of the inductor is connected with a cathode of the first diode, and an anode of the first diode is connected with the anode of the LED light string; a first controllable switch is connected in series between the cathode of the first diode and a ground terminal of the power source; and a first energy storage capacitor is connected in series between the anode of the first diode and the ground terminal of the power source. This is a specific structure of the boost circuit.

Preferably, the boost circuit comprises a first energy storage inductor, and a first diode; one end of the first energy storage inductor is connected with a power source, the other end of the inductor is connected with a cathode of the first diode, and an anode of the first diode is connected with the anode of the LED light string; a first controllable switch is connected in series between the cathode of the first diode and the ground terminal of the power source; and a first energy storage capacitor is connected in series between the anode of the first diode and the ground terminal of the power source. The buck-boost circuit comprises a second controllable switch for energy storage, and a second diode; one end of the second controllable switch is connected with a power source, the other end of the controllable switch is connected with an anode of the second diode, and a cathode of the second diode is connected with the cathode of the LED light string; a second energy storage capacitor is connected in series between the cathode of the second diode and the ground terminal of the power source; and a second energy storage inductor is connected in series between the anode of the second diode and the ground terminal of the power source. This is a specific structure of the boost circuit and the buck-boost circuit.

Preferably, the control end of the first controllable switch is electrically connected with that of the second controllable switch. Thus, the same control signal can be used for control, thereby simplifying the control circuit.

Preferably, the number of the light strings is at least two, and LED light strings are connected in parallel with each other. When a single LED light string cannot meet the requirement of the light source, the LED light strings are connected in parallel to provide sufficient brightness, and thus the application range of the technical scheme of the invention is extended.

A backlight module comprises the LED backlight driving circuit mentioned above.

An LCD device comprises the backlight module mentioned above.

In the invention, because the LEDs are driven by two different circuits comprising a boost circuit which boosts the voltage to drive the anode of the LED light string, and a buck-boost circuit which bucks the voltage to drive the cathode of the LED light string. Thus, the limitation of the maximum voltage supplied by a single boost circuit is broken, the voltage difference between both ends of the LED light string is added, namely more LED lights can be connected in series in a single channel. Therefore, the requirement is met by a single string of LEDs or a few strings of LEDs instead of the original multiple strings of LEDs. The difficulty of the current sharing of the LED light strings is reduced. The type selection of sharing current IC is convenient. The equipment involved therein doesn't need a high voltage resistance. The use of the current sharing ICs is reduced, thereby favoring cost reduction.

### BRIEF DESCRIPTION OF FIGURES

FIG. 1 is a schematic diagram of a conventional LED backlight driving circuit;

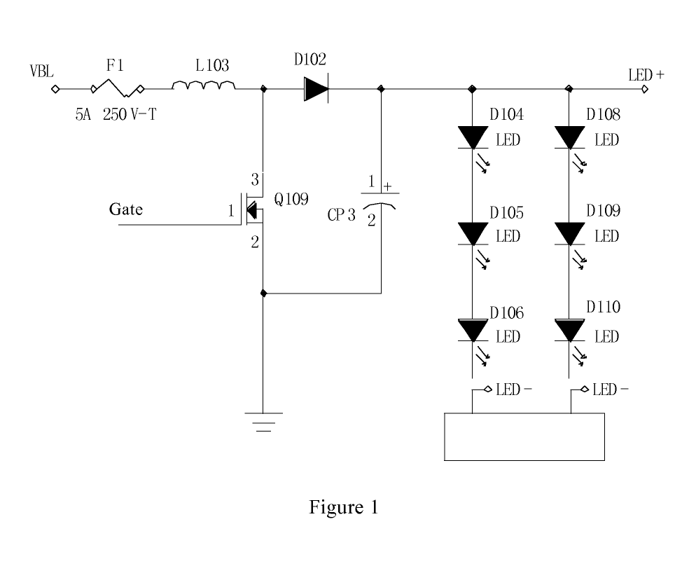

FIG. 2 is a schematic diagram of an LED backlight driving circuit employing a single power source for supplying power in accordance with one embodiment of the invention; and

FIG. 3 is a schematic diagram of an LED backlight driving circuit employing different power sources for supplying power in accordance with one embodiment of the invention.

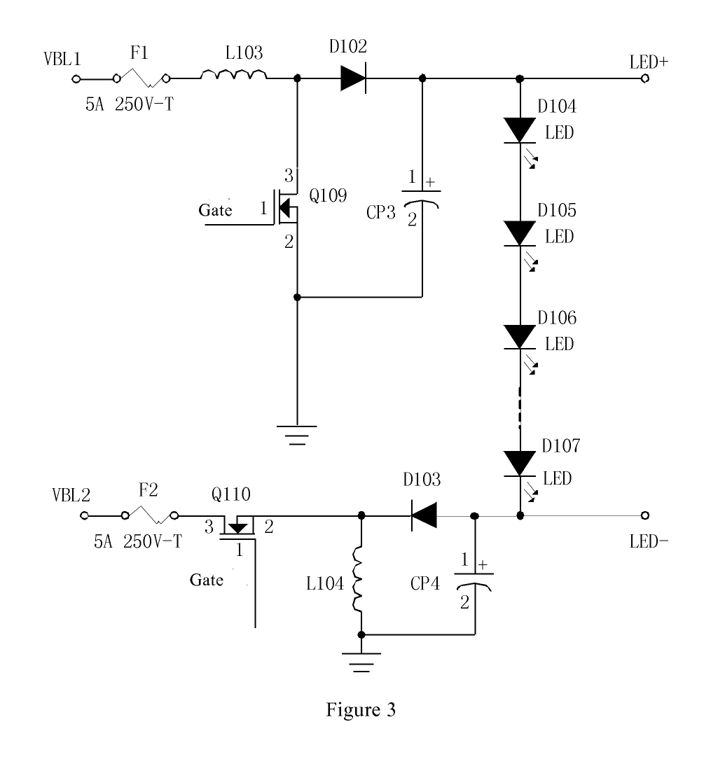

### DETAILED DESCRIPTION

The invention will further be described in detail in accordance with the figures and the preferred examples.

An LCD device comprises a backlight module. The backlight module comprises an LED backlight driving circuit. The LED backlight driving circuit comprises LED light string(s); an anode of the LED light string is connected with a boost circuit, and a cathode of the LED light string is connected with a buck-boost circuit.

### EXAMPLE 1

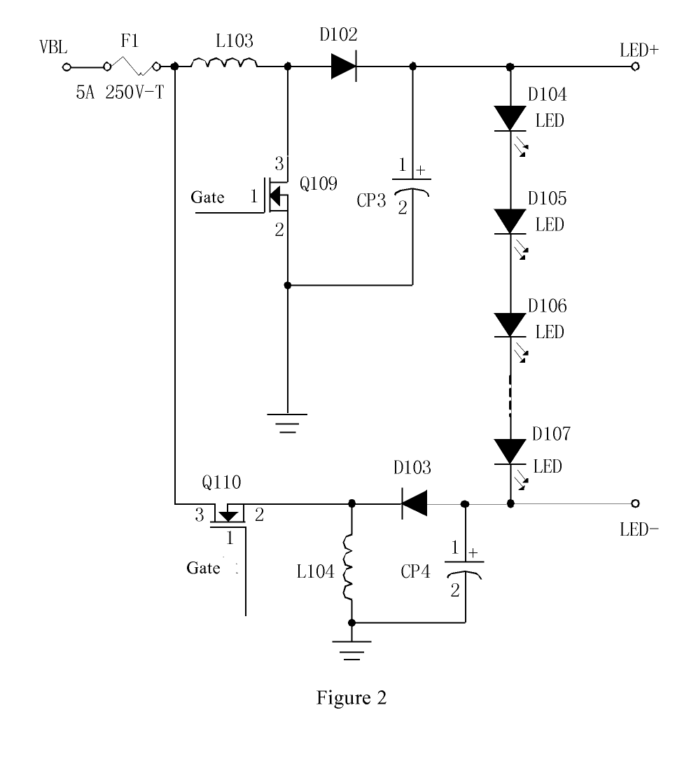

As shown in FIG. 2, the input voltage of the boost circuit is consistent with that of the buck-boost circuit, and both the two circuits are connected with a power source VBL. An LED light string is formed by LED-D104, D105, D106, D107.

The boost circuit comprises a first energy storage inductor L103, and a first diode D102; one end of the first energy storage inductor L103 is connected with the power source VBL, the other end of the inductor L103 is connected with a cathode of the first diode D102, and an anode of the first diode D102 is connected with the anode of the LED light string; a first controllable switch Q109 is connected in series between the cathode of the first diode D102 and the ground terminal of the power source; and a first energy storage capacitor CP3 is connected in series between the anode of the first diode D102 and the ground terminal of the power source.

The buck-boost circuit comprises a second controllable switch Q110 for energy storage, and a second diode D103; one end of the second controllable switch D103 is connected with the power source VBL, the other end of the controllable switch D103 is connected with an anode of the second diode D103, and a cathode of the second diode D103 is connected with the cathode of the LED light string; a second energy storage capacitor CP4 is connected in series between the cathode of the second diode D103 and the ground terminal of the power source; and a second energy storage inductor L104 is connected in series between the anode of the second diode D103 and the ground terminal of the power source. Preferably, the control end of the first controllable switch is electrically connected with that of the second controllable switch. Thus, the same control signal can be used for control, thereby simplifying the control circuit.

In the invention, because the LEDs are driven by two different circuits comprising a boost circuit which comprises a first energy storage inductor L103, a first diode D102, and a first controllable switch Q109 and boosts the power source VBL to a certain high voltage to drive the anode of the LED light string, and a buck-boost circuit which comprises a second energy storage inductor L104, a second diode D103, and a second controllable switch Q110 and bucks the power source VBL to a certain negative voltage to drive the cathode of the LED light string. Thus, the limitation of the maximum voltage supplied by the single boost circuit is broken, the voltage difference between both ends of the LED light string is added, namely more LED lights can be connected in series in a single channel. Therefore, the requirement is met by a single string of LEDs or a few strings of LEDs instead of the original multiple strings of LEDs. For example, if the anode of the LED light string is boosted to 80 V, and the cathode of the LED light string is bucked to −80 V, the voltage difference between the two ends of the LED light string is 160 V; therefore, more LEDs can be driven.

### EXAMPLE 2

As shown in FIG. 2, the input end of the boost circuit is connected with a power source VBL1, the input end of the buck-boost circuit is connected with a power source VBL2, and the voltage of VBL2 is lower than that of the VBL1. An LED light string is formed by LED-D104, D105, D106, and D107.

The boost circuit comprises a first energy storage inductor L103, and a first diode D102; one end of the first energy storage inductor L103 is connected with the power source VBL1, the other end of the inductor L103 is connected with a cathode of the first diode D102, and an anode of the first diode D102 is connected with the anode of the LED light string; a first controllable switch Q109 is connected in series between the cathode of the first diode D102 and a ground terminal of the power source; and a first energy storage capacitor CP3 is connected in series between the anode of the first diode D102 and the ground terminal of the power source.

The buck-boost circuit comprises a second controllable switch Q110 for energy storage, and a second diode D103; one end of the second controllable switch D103 is connected with the power source VBL2, the other end of the controllable switch D103 is connected with an anode of the second diode D103, and a cathode of the second diode D103 is connected with the cathode of the LED light string; a second energy storage capacitor CP4 is connected in series between the cathode of the second diode D103 and the ground terminal of the power source; and a second energy storage inductor L104 is connected in series between the anode of the second diode D103 and the ground terminal of the power source. Preferably, the control end of the first controllable switch is electrically connected with that of the second controllable switch. Thus, the same control signal can be used for controlling these controllable switches, thereby simplifying the control circuit.

In the invention, because the LEDs are driven by two different circuits comprising a boost circuit which comprises a first energy storage inductor L103, a first diode D102, and a first controllable switch Q109 and boosts the power source VBL1 to a certain high voltage to drive the anode of the LED light string, and a buck-boost circuit which comprises a second energy storage inductor L104, a second diode D103, and a second controllable switch Q110 and bucks the power source VBL2 to a certain negative voltage to drive the cathode of the LED light string. Because both the boost circuit and the buck-boost circuit have a certain adjustment range based on the input voltage, the input voltage of the boost circuit is high, and the boosted voltage thereof is higher; the input voltage of the buck-boost circuit is low, and the bucked voltage thereof is lower. Therefore, the voltage difference between both ends of the LED light string can be further added, which means that the single LED light string can drive more LEDs. For example, if the voltage of the VBL1 is consistent with that of the VBL, the LED anode is boosted to −80 V after being boosted by the boost circuit; the voltage of the VBL2 is lower than that of the VBL1, the voltage of the LED cathode is further bucked by using the same buck-boost circuit, such as bucked to −100 V. Thus, the voltage difference between the two ends of the LED light string is 180 V, thereby driving more LEDs as compared with the first example.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LED backlight driving circuit, comprising: LED light string(s); an anode of said LED light string is connected with a boost circuit, and a cathode of said LED light string is connected with a buck-boost circuit.

2. The LED backlight driving circuit of claim 1, wherein the input voltage of said boost circuit is consistent with that of said buck-boost circuit.

3. The LED backlight driving circuit of claim 1, wherein the input voltage of said boost circuit is higher than that of said buck-boost circuit.

4. The LED backlight driving circuit of claim 1, wherein said buck-boost circuit comprises a second controllable switch for energy storage, and a second diode; one end of said second controllable switch is connected with a power source, the other end of said controllable switch is connected with an anode of said second diode, and a cathode of said second diode is connected with the cathode of said LED light string; a second energy storage capacitor is connected in series between the cathode of said second diode and a ground terminal of said power source; and a second energy storage inductor is connected in series between the anode of said second diode and the ground terminal of said power source.

5. The LED backlight driving circuit of claim 1, wherein said boost circuit comprises a first energy storage inductor, and a first diode; one end of said first energy storage inductor is connected with a power source, the other end of said inductor is connected with a cathode of said first diode, and an anode of said first diode is connected with the anode of said LED light string; a first controllable switch is connected in series between the cathode of said first diode and a ground terminal of said power source; and a first energy storage capacitor is connected in series between the anode of said first diode and the ground terminal of said power source.

6. The LED backlight driving circuit of claim 1, wherein said boost circuit comprises a first energy storage inductor, and a first diode; one end of said first energy storage inductor is connected with a power source, the other end of said inductor is connected with a cathode of said first diode, and an anode of said first diode is connected with the anode of said LED light string; a first controllable switch is connected in series between the cathode of said first diode and a ground terminal of said power source; a first energy storage capacitor is connected in series between the anode of said first diode and the ground terminal of said power source; said buck-boost circuit comprises a second controllable switch for energy storage, and a second diode; one end of said second controllable switch is connected with a power source, the other end of said controllable switch is connected with an anode of said second diode, and a cathode of said second diode is connected with the cathode of said LED light string; a second energy storage capacitor is connected in series between the cathode of said second diode and a ground terminal of said power source; and a second energy storage inductor is connected in series between the anode of said second diode and the ground terminal of said power source.

7. The LED backlight driving circuit of claim 6, wherein a control end of said first controllable switch is electrically connected with that of said second controllable switch.

8. The LED backlight driving circuit of claim 1, wherein the number of said light strings is at least two, and light strings are connected in parallel with each other.

9. A backlight module, comprising: an LED backlight driving circuit; wherein said LED backlight driving circuit comprises LED light string(s); an anode of said LED light string is connected with a boost circuit, and a cathode of said LED light string is connected with a buck-boost circuit.

10. The backlight module of claim 9, wherein the input voltage of said boost circuit is consistent with that of said buck-boost circuit.

11. The backlight module of claim 9, wherein the input voltage of said boost circuit is higher than that of said buck-boost circuit.

12. The backlight module of claim 9, wherein said buck-boost circuit comprises a second controllable switch for energy storage, and a second diode; one end of said second controllable switch is connected with a power source, the other end of said controllable switch is connected with an anode of said second diode, and a cathode of said second diode is connected with the cathode of said LED light string; a second energy storage capacitor is connected in series between the cathode of said second diode and a ground terminal of said power source; and a second energy storage inductor is connected in series between the anode of said second diode and the ground terminal of said power source.

13. The backlight module of claim 9, wherein said boost circuit comprises a first energy storage inductor, and a first diode; one end of said first energy storage inductor is connected with a power source, the other end of said inductor is connected with a cathode of said first diode, and an anode of said first diode is connected with the anode of said LED light string; a first controllable switch is connected in series between the cathode of said first diode and a ground terminal of said power source; and a first energy storage capacitor is connected in series between the anode of said first diode and the ground terminal of said power source.

14. The backlight module of claim 9, wherein said boost circuit comprises a first energy storage inductor, and a first diode; one end of said first energy storage inductor is connected with a power source, the other end of said inductor is connected with a cathode of said first diode, and an anode of said first diode is connected with the anode of said LED light string; a first controllable switch is connected in series between the cathode of said first diode and a ground terminal of said power source; and a first energy storage capacitor is connected in series between the anode of said first diode and the ground terminal of said power source; said buck-boost circuit comprises a second controllable switch for energy storage, and a second diode; one end of said second controllable switch is connected with a power source, the other end of said controllable switch is connected with an anode of said second diode, and a cathode of said second diode is connected with the cathode of said LED light string; a second energy storage capacitor is connected in series between the cathode of said second diode and a ground terminal of said power source; and a second energy storage inductor is connected in series between the anode of said second diode and the ground terminal of said power source.

15. The backlight module of claim 14, wherein a control end of said first controllable switch is electrically connected with that of said second controllable switch.

16. The backlight module of claim 9, wherein the number of said light strings is at least two, and light strings are connected in parallel with each other.

17. An LCD device, comprising: a backlight module; wherein said backlight module comprises an LED backlight driving circuit; said LED backlight driving circuit comprises LED light string(s); an anode of said LED light string is connected with a boost circuit, and a cathode of said LED light string is connected with a buck-boost circuit.

18. The LCD device of claim 17, wherein said buck-boost circuit comprises a second controllable switch for energy storage, and a second diode; one end of said second controllable switch is connected with a power source, the other end of said controllable switch is connected with an anode of said second diode, and a cathode of said second diode is connected with the cathode of said LED light string; a second energy storage capacitor is connected in series between the cathode of said second diode and a ground terminal of said power source; and a second energy storage inductor is connected in series between the anode of said second diode and the ground terminal of said power source.

19. The LCD device of claim 17, wherein said boost circuit comprises a first energy storage inductor, and a first diode; one end of said first energy storage inductor is connected with a power source, the other end of said inductor is connected with a cathode of said first diode, and an anode of said first diode is connected with the anode of said LED light string; a first controllable switch is connected in series between the cathode of said first diode and a ground terminal of said power source; and a first energy storage capacitor is connected in series between the anode of said first diode and the ground terminal of said power source.

20. The LCD device of claim 17, wherein said boost circuit comprises a first energy storage inductor, and a first diode; one end of said first energy storage inductor is connected with a power source, the other end of said inductor is connected with a cathode of said first diode, and an anode of said first diode is connected with the anode of said LED light string; a first controllable switch is connected in series between the cathode of said first diode and a ground terminal of said power source; and a first energy storage capacitor is connected in series between the anode of said first diode and the ground terminal of said power source; said buck-boost circuit comprises a second controllable switch for energy storage, and a second diode; one end of said second controllable switch is connected with a power source, the other end of said controllable switch is connected with an anode of said second diode, and a cathode of said second diode is connected with the cathode of said LED light string; a second energy storage capacitor is connected in series between the cathode of said second diode and a ground terminal of said power source; and a second energy storage inductor is connected in series between the anode of said second diode and the ground terminal of said power source.
